(19) United States
(12) Patent Application Publication
(10) Pub. No.: US 2024/0100663 A1
(43) Pub. Date: Mar. 28, 2024

(54) Hand-Held Power Tool with a Torque Coupling

(71) Applicant: Robert Bosch GmbH, Stuttgart (DE)

(72) Inventor: Han Hoong-Sebastian Chin, Penang (MY)

(21) Appl. No.: 18/473,982

(22) Filed: Sep. 25, 2023

(30) Foreign Application Priority Data
Sep. 28, 2022 (DE) 10 2022 210 260.6

(51) Int. Cl. B25B 23/142; B25B 21/00

(52) U.S. Cl. CPC B25B 23/1427; B25B 21/00

(57) ABSTRACT

A hand-held power tool, in particular a screwdriver, has a housing in which at least one gear assembly and a drive motor for rotationally driving a toolholder are arranged. The power tool further includes a torque coupling, which includes a torque adjustment unit associated with the gear assembly, and with which a transmission element acted upon by at least two spring elements is associated. A torque level of the torque coupling can be adjusted via an operating element actuable by a user. The at least two spring elements are arranged between the transmission element and a spring retaining ring. The spring retaining ring is arranged on a side of the transmission element facing away from the gear assembly and is connected to the operating element via a toothing for adjusting a torque level. The spring retaining ring includes bearing points associated with the at least two spring elements.

This application claims priority under 35 U.S.C. § 119 to patent application no. DE 10 2022 210 260.6, filed on Sep. 28, 2022 in Germany, the disclosure of which is incorporated herein by reference in its entirety.

### BACKGROUND

The disclosure relates to a hand-held power tool, in particular a screwdriver, having a housing in which at least one gear assembly and a drive motor for rotationally driving a toolholder are arranged, and having a torque coupling which comprises a torque adjustment unit which is associated with the gear assembly, and with which a transmission element acted upon by at least two spring elements is associated, a torque level of the torque coupling being adjusted via an operating element actuable by the user, the at least two spring elements being arranged between the transmission element and a spring retaining ring, and the spring retaining ring being arranged on a side of the transmission element facing away from the gear assembly and connected to the operating element via a toothing for adjusting a torque level. A hand-held power tool designed as a screwdriver is known from CN 103862419 A. The screwdriver comprises a torque coupling having a torque adjustment unit that comprises an adjustment sleeve for adjusting a torque level of the torque coupling. Spring elements arranged between a transmission element and the adjustment sleeve are associated with the torque adjustment unit.

### SUMMARY

The disclosure relates to a hand-held power tool, in particular a screwdriver, having a housing in which at least one gear assembly and a drive motor for rotationally driving a toolholder are arranged, and having a torque coupling which comprises a torque adjustment unit which is associated with the gear assembly, and with which a transmission element acted upon by at least two spring elements is associated, a torque level of the torque coupling can being adjusted via an operating element actuable by the user, the at least two spring elements being arranged between the transmission element and a spring retaining ring, and the spring retaining ring being arranged on a side of the transmission element facing away from the gear assembly and connected to the operating element via a toothing for adjusting a torque level. The spring retaining ring comprises bearing points locations associated with the at least two spring elements. The disclosure therefore enables a hand-held power tool having a torque coupling and a torque adjustment unit to be provided, in which a secure and reliable arrangement of the at least two spring elements on the spring retaining ring can be enabled by the spring retaining ring with the bearing points.

Preferably, the bearing points are designed as bars and/or receptacles. Thus, suitable bearing points can be provided in a simple manner.

Preferably, the bearing points along a longitudinal extension of the housing are of different lengths.

Varying spring forces can thereby be easily and straightforwardly used.

According to one embodiment, the bearing points have a length in the range of 7 mm to 11.5 mm.

Secure and reliable bearing points can therefore be provided.

Preferably, a plurality of bearing points arranged in the circumferential direction of the spring retaining ring are provided.

A stable and robust arrangement of the spring elements on the spring retaining ring can be enabled thereby.

Preferably, the bearing points are arranged alternately with different lengths in the circumferential direction.

A light and straightforward arrangement of the bearing points on the spring retaining ring can therefore be enabled.

The bearing points are preferably designed integrally with the spring retaining ring.

A compact spring retaining ring can be provided thereby.

According to one embodiment, the bearing points designed as the receptacle are designed in the manner of a semi-shell or cylinder.

Suitable bearing points for receiving the at least two spring elements can thus be provided in a simple manner.

Preferably, the spring retaining ring comprises an internal recess having at least one recess to be rotationally secured on a coupling housing associated with the torque coupling.

A secure and reliable arrangement of the spring retaining ring on the coupling housing can be enabled thereby.

Preferably, the spring retaining ring comprises at least one weight reduction recess radially between its outer circumference and the bearing points.

A weight-optimized spring retaining ring can therefore be provided easily and straightforwardly.

Preferably, the at least two spring elements adjoin on a side of the transmission element facing the spring retaining ring.

An arrangement of the at least two spring elements on the transmission element can thereby be enabled in a simple manner.

According to one embodiment, the torque adjustment unit comprises at least one detent body arranged along the longitudinal extension of the housing on an end face of the gear assembly facing the transmission element, the at least one detent body being designed as a pin and/or a ball.

A detent body for the torque adjustment unit can thereby be easily and simply provided.

Preferably, the end face of the gear assembly faces a ring gear associated with the gear assembly, and the at least one detent body is arranged on an end face of the ring gear.

A secure and robust arrangement of the at least one detent body can thus be enabled.

The coupling housing comprises first and second receptacles arranged facing the spring retaining ring, wherein the first receptacle is designed to receive the at least one detent body and the second receptacles are designed to receive the at least two spring elements.

An arrangement of the at least two spring elements on the coupling housing can thereby be enabled in a simple manner.

Preferably, the transmission element comprises internal recesses for arrangement on the coupling housing.

The transmission element can thereby be easily and simply arranged on the coupling housing.

### BRIEF DESCRIPTION OF THE DRAWINGS

The disclosure is explained in further detail in the following description with reference to exemplary embodiments shown in the drawings. Shown are:

FIG. 1 a side view of a hand-held power tool according to the disclosure having an exemplary torque adjustment unit,

FIG. 2 an exploded view of the torque adjustment unit in FIG. 1,

FIG. 3 a longitudinal section through the torque adjustment unit in FIG. 1 and FIG. 2,

FIG. 4 a top perspective view of a spring retaining ring associated with the torque adjustment unit in FIG. 1 to FIG. 3, and

FIG. 5 a sectional view of the spring retaining ring in FIG. 4.

### DETAILED DESCRIPTION

Elements having the same or a comparable function are provided with the same reference characters in the drawings and are described in detail only once.

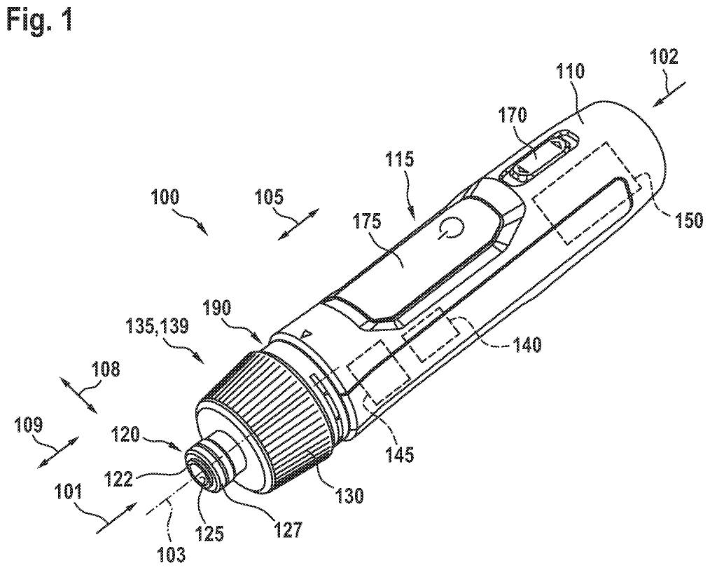

FIG. 1 illustrates an exemplary hand-held power tool 100 illustrated as having an elongated housing 110. By way of the elongated housing 110, the hand-held power tool 100 is, e.g., designed in what is referred to as a “rod shape.” Preferably, the hand-held power tool 100 is designed as a screwdriver, in particular as a rod screwdriver. According to one embodiment, the hand-held power tool 100 can be mechanically and electrically connected to a power supply unit for network-independent power supply. Preferably, the power supply unit 150 is designed as a battery or battery pack.

Preferably, at least one drive motor 140 is arranged in the illustratively elongated housing 110 for driving a toolholder 120. The toolholder 120 preferably comprises at least regionally a tubular or sleeve-shaped base body 122. The at least regionally tubular base body 122 preferably comprises an internal receptacle 125 for receiving an insertion tool. The internal receptacle 125 is preferably an internal hexagonal receptacle for a screwdriver bit or bit insertion tools in general.

The elongated housing 110 preferably comprises a cylindrical, illustratively at least partially sleeve-shaped base body, having a first axial end 101 and an opposite second axial end 102, the toolholder 120 being, e.g., arranged in the region of the first axial end 101. For the purpose of illustration, a longitudinal direction 105 of the elongated housing 110 is designed between the first and second axial ends 101, 102.

In the hand-held power tool 100 shown in FIG. 1, the toolholder 120, the drive motor 140, and the housing 110 are arranged along a common longitudinal axis, preferably congruent to an axis of rotation 103 of the toolholder 120. Preferably, all elements of the hand-held power tool 100 are arranged in the elongated housing 110. Compared to a hand-held power tool having a gun-shaped housing in which the battery is arranged perpendicular to the drive motor, which is well known from the prior art, the battery 150 is then also preferably arranged in the housing 110 in the toolholder 100.

According to one embodiment, the drive unit 140 is associated with a gear assembly 145. The gear assembly 145 is preferably designed as a planetary gear train. Furthermore, a sliding switch 170 is preferably provided, which is arranged on the housing 110 in order to activate a reversing operation of the drive motor 140.

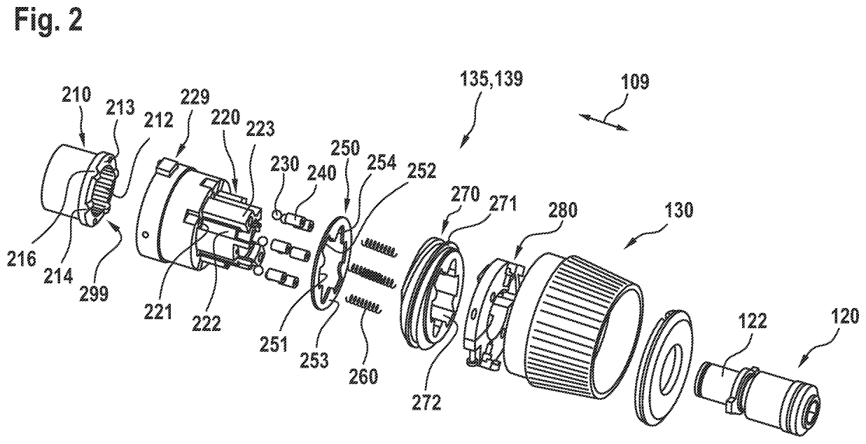

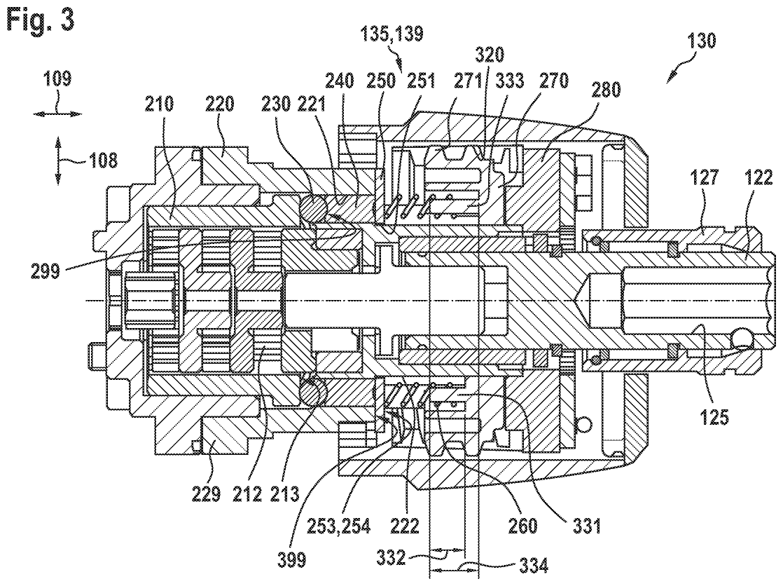

The housing 110 preferably also comprises a torque coupling 135 at its axial end 101. The torque coupling 135 comprises a torque adjustment unit 139 associated with the gear assembly 145. A respectively desired, e.g. work-specific torque limit, or the torque level of the torque coupling 135 can thereby be set via an operating element 130 actuable by a user. The operating element 130 is preferably designed as a rotatable operating sleeve. Furthermore, an operating mode display unit 190 is arranged illustratively axially between the operating element 130 and the elongated housing 110, which preferably visualizes a set operating mode as well as a torque step. Preferably, the torque coupling 135 is arranged on the gear assembly 145, in particular in a coupling housing (220 in FIG. 2 and FIG. 3). In contrast, the torque adjustment unit 139 is preferably arranged radially within the operating element 130.

It should be noted at this point that the disclosure is not limited to hand-held power tools designed as a rod screwdrivers, but can be applicable to all hand-held power tools having a torque coupling 135 and a torque adjustment unit 139. In other words, the disclosure is not limited to hand-held power tools with elongated housings, but can be implemented independently of a particular type of housing present.

According to one embodiment, there is an operating element 175 provided to activate the drive motor 140. An operation of the operating element 175 by a user preferably activates the drive motor 140. The operating element 175 is preferably arranged at a grip region 115 of the elongate housing 110.

Preferably, a locking device 180 is provided for releasably locking an insertion tool which can be arranged in the internal receptacle 125. Preferably, the locking device 180 comprises a locking sleeve 127.

The toolholder 120 illustratively comprises an axial longitudinal extension 109. It is noted that, in the context of the disclosure, the term “axial” is understood to mean a direction along the longitudinal extension 109 of the toolholder 120. Furthermore, the term “radial” is understood to mean a direction approximately perpendicular to the longitudinal extension 109 of the toolholder 120. Thus, a radial direction 108 is arranged approximately perpendicular to the longitudinal direction 105 of the elongated housing 110 or perpendicular to the longitudinal extension 109 of the toolholder 120. Furthermore, the axial direction is arranged substantially parallel or congruent to the longitudinal extension 109 of the toolholder 120, or parallel or congruent to the axis of rotation 103 of the toolholder 120.

FIG. 2 shows the torque coupling 135 with the torque adjustment unit 139 of FIG. 1. FIG. 2 illustrates a ring gear 210 associated with the gear assembly 145 of FIG. 1, which comprises a hollow cylindrical or sleeve-shaped base body, which has internal teething 212 on its inner circumference. On an illustratively right-hand end face 213 facing the torque adjustment unit 139 or the toolholder 120, the ring gear 210 preferably comprises at least one axial impact element 214, 216. Illustratively, along a circumference of the ring gear 210, six impact elements 214, 216 are arranged at the end face 213. Preferably, the impact elements 214, 216 are arranged at regular intervals with respect to each other. The ring gear 210 is preferably arranged such that the end face 213 of the ring gear 210 is arranged on an end face 299 associated with the gear assembly 145.

Preferably, the ring gear 210 is arranged in segments in an internal receptacle of a coupling housing 220 associated with the torque coupling 135. The coupling housing 220 includes an illustrative left hollow cylindrical or annular receiving portion 229 for receiving, at least in segments, the ring gear 210 of the gear assembly 145. Axially adjacent in the direction of the torque coupling 135, the coupling housing 220 preferably comprises axial bars 223 arranged in the circumferential direction of the hollow cylindrical receiving section 229. A receptacle 222 is preferably designed between two adjacent bars 223. The receptacle 222 is illustratively designed in the manner of a semi-shell. Preferably, each receptacle 222 is associated with a receptacle 221. The receptacle 221 is preferably formed in the hollow cylindrical receiving portion 229 as an internal receptacle. According to one embodiment, the receptacle 221 is designed in the manner of a cylinder. In the axial direction 109, the two receptacles 221, 222 are connected to one another or merge into one another.

Further, a transmission element 250 is preferably associated with the torque coupling 135. The transmission element 250 is preferably disc shaped and comprises an internal receptacle 252. The internal receptacle 252 is designed to be arranged on the coupling housing 220, particularly on the bars 223. For this purpose, the inner receptacle 252 comprises recesses 251 and contact surfaces 254 alternating in the circumferential direction. The recesses 251 preferably have a larger inner diameter than the contact surfaces 254.

In addition, a spring retaining ring 270 is preferably associated with the torque coupling 135. The spring retaining ring 270 preferably comprises a hollow cylindrical or annular base body with a toothing 271 arranged on the outer circumference and with at least one recess 272 arranged on its inner circumference. Preferably, the at least one recess 272 is designed to be rotationally secured on the coupling housing 220. Furthermore, the spring retaining ring 270 is illustratively connected to the operating element 130 for adjusting a torque level via the toothing 271.

Alternatively, a limit stop element 280 is associated with the torque coupling 135 designed to form an axial stop of the spring retaining ring 270 toward the toolholder 120.

Preferably, at least two and illustratively six spring elements 260 are associated with the transmission element 250. Preferably, the spring elements 260 are of the same type and, in particular, are designed as spiral springs. However, different spring elements can also be used. All spring elements 260 can be the same length or have different lengths. Preferably, the spring elements 260 are arranged axially between the transmission element 250 and the spring retaining ring 270. The spring elements 260 in this case adjoin a side 253 of the transmission element 250 facing the spring retaining ring 270. The spring retaining ring 270, in turn, is preferably arranged on a side of the transmission element 250 facing away from the gear assembly 145, or facing the toolholder 120.

Preferably, the torque adjustment unit 139 comprises at least one detent body 230, 240 arranged along the longitudinal extension 103 of the housing 110 or in the axial direction 109 on the end face 299 of the gear assembly 145 facing the transmission element 250. The at least one detent body 230, 240 is preferably designed as a pin and/or a ball. Illustratively, the detent bodies 240 are designed according to the type of pin and the detent bodies 230 are designed according to the type of balls. The detent bodies 230 are in this case arranged facing the ring gear 210 and the detent bodies 240 are arranged facing the transmission element 250. In particular, the detent bodies 240 adjoin the transmission element 250. Preferably, the detent bodies 230, 240 are arranged on an end face 213 of the ring gear 210. The transmission element 250 is preferably arranged axially between the detent bodies 240 designed as pins and the spring elements 260.

Furthermore, the receptacles 221 of the coupling housing 220 are preferably designed to receive the detent bodies 230, 240. Moreover, the receptacles 222 are preferably designed to receive the spring elements 260.

FIG. 3 shows the torque coupling 135 with the torque adjustment unit 139 of FIG. 1 and FIG. 2. FIG. 3 illustrates the arrangement of the detent bodies 230, 240 on the end face 213 of the ring gear 210, or rather the end face 299 of the gear assembly 145. Moreover, in FIG. 3, the radial arrangement of the ring gear 210 in the coupling housing 220 is visualized. FIG. 3 also shows the arrangement of the detent bodies 230, 240 radially within the coupling housing 220 or within the preferably cylindrical receptacles 221 of the coupling housing 220.

FIG. 3 also illustrates the arrangement of the transmission element 250 on the bars 223 of the coupling housing 220, in which case the transmission element 250 axially adjoins an end face 399 of the hollow cylindrical receiving portion 229 of the coupling housing 220 facing the toolholder 120. Furthermore, the transmission element 250 is arranged axially between the detent bodies 230, 240 and the spring elements 260.

Preferably, the operating element 130 comprises a toothing 320 on its inner side facing the spring retaining ring 270. The toothing 320 is preferably designed as an internal thread and the toothing 271 of the spring retaining ring 270 is designed as an external thread, wherein the two toothings 320, 271 are arranged facing each other for adjusting a torque level. When a desired torque level is set, an axial position of the spring retaining ring 270 can thus be changed by displacement. Different spring forces of the spring elements 260 can be adjusted due to the different axial positions of the spring retaining ring 270. When the set spring forces are exceeded, the torque coupling 135 disengages and the toolholder 120 goes into an idle state in which no torque is transmitted.

Furthermore, FIG. 3 shows the arrangement of the spring elements 260 in the receptacles 222 of the coupling housing 220. Preferably, the spring retaining ring 270 comprises bearing points 331, 333 associated with the spring elements 260. Preferably, the bearing points 331, 333 are designed as bars and/or receptacles. Illustratively, the bearing points 331, 333 are designed as axial bars on whose outer circumference an associated inner circumference of a spring element 260 is arranged in segments.

Preferably, the bearing points 331, 333 along the longitudinal extension 103 of the housing 110 in FIG. 1, or in the axial direction 109, have different lengths 332, 334. Preferably, the bearing point 331 has a length 332 and the bearing point 333 has a length 334. According to one embodiment, the bearing points 331, 332 have an axial length 332, 334 in the range of 7 mm to 11.5 mm. Preferably, the lengths 332, 334 are between 7 mm and 9 mm. Preferably, the lengths 332, 334 are between 9.5 mm and 11.5 mm.

Preferably, a plurality of bearing points 331, 332 arranged in the circumferential direction of the spring retaining ring 270 are provided. The bearing points 331, 332 with the different lengths 332, 334 are in this case preferably arranged alternately in a circumferential direction. It is noted, however, that the bearing points 331, 332 can also be circumferentially arranged in predetermined patterns, e.g. in the circumferential direction, two bearing points 331 of length 332 are arranged next to each other and then, for example, three bearing points 332 of length 334, are arranged next to each other.

According to one embodiment, the bearing points 331, 332 are designed integrally with the spring retaining ring 270. Preferably, the bearing points 331, 332 designed as the receptacle are designed in the manner of a semi-shell or cylinder.

Illustratively, the torque adjustment unit 139 is arranged radially between the operating element 130 and the coupling housing 220 and the bars 223. The torque adjustment unit 139 comprises, e.g., the operating element 130, the spring retaining ring 270, the spring elements 260 as well as the transmission element 250. The torque coupling 135, on the other hand, is preferably arranged radially between the coupling housing 220 and a coupling part of the toolholder 120. The torque coupling 135 is in this case illustratively arranged axially between the ring gear 210 and the torque adjustment unit 139. The torque coupling 135 is thereby, e.g., associated with the ring gear 210, in particular the axial impact elements 214, 216 of the ring gear 210, as well as the detent bodies 230, 240. Preferably, the detent bodies 230 are arranged on the ring gear 210 and the detent bodies 240 are arranged between the detent bodies 230 and the transmission element 250. The detent bodies 240 in this case preferably adjoin a side of the transmission element 250 facing away from the spring retaining ring 270.

Within the gear assembly 145, torque and speed conversion results in a support torque that is transmitted to the ring gear 210 from the planetary gears of a front, illustratively left, planetary stage. The torque coupling 135 responds when the support torque becomes greater than an applied holding torque, causing the ring gear 210 to ultimately slip or spin. In this case, transmission between the gear assembly 145 and the toolholder 120 is interrupted or suspended, or at least limited. The respective holding torque acting on the ring gear 210 is dependent on the axial position of the spring retaining ring 270 and thus on the rotational position of the operating element 130.

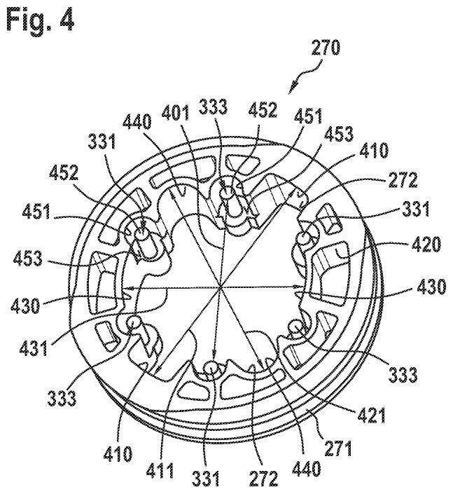

FIG. 4 shows the spring retaining ring 270 of the torque coupling 135 and the torque adjustment unit 139 in FIG. 1 to FIG. 3 with the toothing 271 and recess 272 arranged on its outer circumference, as well as the illustrative six bearing points 331, 333. Preferably, the recess 272 is associated with protrusions 410, 430, 440. The protrusions 410, 430, 440 are preferably arranged in the circumferential direction between the bearing points 331, 333. Preferably, a protrusion 410, 430, 440 is arranged between each of the two adjacent bearing points 331, 333 in the circumferential direction of the spring retaining ring 270. Illustratively, two protrusions 410, 430, 440 are each arranged to be diametrically opposite. Preferably, the protrusion 410 forms an approximately pot-shaped recess portion of the recess 272 and the protrusion 440 forms an approximately semi-circular recess portion. The protrusion 430 illustratively forms a recess portion according to the type of a circle segment. The protrusion 410 preferably has a diameter 411, the protrusion 440 has a diameter 421, and the protrusion 430 has a diameter 431. Two bearing points 331, 333 are similarly each arranged diametrically opposite and have a diameter 401. Preferably, the diameters 411, 421 are larger than the diameters 401, 431. According to one embodiment, the diameters 401, 431 are equal.

FIG. 4 further shows the bearing points 331, 333, which illustratively each comprise a receptacle 451 in the manner of a semi-shell and a central bar 452. The spring element 260 of FIG. 2 and FIG. 3 can thereby be received at its outer circumference in segments at the receptacle 451 and can be received at its inner circumference at the bar 452. Furthermore, a bearing point 331, 333 is preferably associated with a base surface 453 on which the spring element 260 of FIG. 2 and FIG. 3 adjoins with its axial end facing the toolholder 120 of FIG. 1 to FIG. 3. The lengths 332, 334 are preferably designed between the base surface 453 and an axial end face associated with the spring retaining ring 270. An axial position of the base surface 453 thus forms one of the respective lengths 331, 333. It is noted that the bearing points 331, 333, as described hereinabove, can also be designed merely as a receptacle 451 or a cylindrical recess, or merely as a bar 452.

According to one embodiment, the spring retaining ring 270 comprises at least one weight reduction recess 420 radially between its outer circumference and the bearing points 331, 333. Illustratively, the weight reduction recess or recesses 420 are each designed as a recess, but can also be designed as a through-opening.

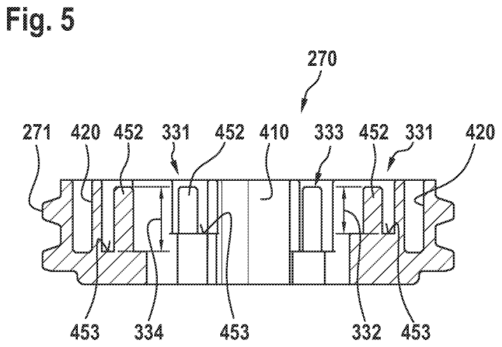

FIG. 5 shows the spring retaining ring 270 from FIG. 2 to FIG. 4 with the bearing points 331, 333 having different lengths 332, 334. FIG. 5 furthermore illustrates the arrangement of the weight reduction recesses 420 that are illustratively arranged radially between the outer circumference of the spring retaining ring 270 or the toothing 271, and the bearing points 331, 333.

What is claimed is:

1. A hand-held power tool, comprising:
a housing;
at least one gear assembly located in the housing;
a toolholder;
a drive motor configured to rotationally drive the toolholder, the drive motor located in the housing;
a torque coupling including a torque adjustment unit associated with the at least one gear assembly;
at least two spring elements;
a spring retaining ring;
a transmission element configured to be acted upon by the at least two spring elements, the transmission element associated with the torque coupling;
an operating element actuable by a user and configured to adjust a torque level of the torque coupling,
wherein the at least two spring elements are arranged between the transmission element and the spring retaining ring,
wherein the spring retaining ring is arranged on a side of the transmission element facing away from the at least one gear assembly,
wherein the spring retaining ring is connected to the operating element via a toothing for adjusting the torque level, and
wherein the spring retaining ring comprises bearing points associated with the at least two spring elements.

2. The hand-held power tool according to claim 1, wherein the bearing points are configured as bars and/or receptacles.

3. The hand-held power tool according to claim 1, wherein the bearing points have different lengths along a longitudinal extension of the housing.

4. The hand-held power tool according to claim 3, wherein the bearing points have a length from 7 mm to 11.5 mm.

5. The hand-held power tool according to claim 1, wherein the spring retaining ring includes a plurality of the bearing points arranged in a circumferential direction of the spring retaining ring.

6. The hand-held power tool according to claim 3, wherein the bearing points having different lengths are arranged alternately in a circumferential direction.

7. The hand-held power tool according to claim 1, wherein the bearing points are integral with the spring retaining ring.

8. The hand-held power tool according to claim 2, wherein the bearing points are configured as receptacles having a half-shell shape or a cylinder shape.

9. The hand-held power tool according to claim 1, wherein the spring retaining ring defines an internal recess having at least one recess configured to be rotationally secured on a coupling housing associated with the torque coupling.

10. The hand-held power tool according to claim 1, wherein the spring retaining ring defines at least one weight reduction recess located radially between an outer circumference of the spring retaining ring and the bearing points.

11. The hand-held power tool according to claim 1, wherein the at least two spring elements adjoin a side of the transmission element facing the spring retaining ring.

12. The hand-held power tool according to claim 3, wherein:
the torque adjustment unit includes at least one detent body arranged along the longitudinal extension of the housing on an end face of the at least one gear assembly facing the transmission element, and
the at least one detent body is configured as a pin and/or a ball.

13. The hand-held power tool according to claim 12, wherein:
the end face of the at least one gear assembly faces a ring gear associated with the gear assembly, and
the at least one detent body is arranged on an end front face of the ring gear.

14. The hand-held power tool according to claim 9, wherein:
the coupling housing comprises a first receptacle and at least two second receptacles arranged facing the spring retaining ring,
the first receptacle is configured to receive the at least one detent body, and
the at least two second receptacles are configured to receive the at least two spring elements.

15. The hand-held power tool according to claim 9, wherein the transmission element includes internal recesses operably connected to the coupling housing.
